(19) United States
(12) Patent Application Publication
(10) Pub. No.: US 2025/0345935 A1
(43) Pub. Date: Nov. 13, 2025

(54) MANIPULATION TASK SOLVER

(71) Applicant: Honda Motor Co., Ltd., Tokyo (JP)

(72) Inventors: Shaunak A. MEHTA, Blacksburg, VA (US); Rana SOLTANI ZARRIN, Los Gatos, CA (US)

(21) Appl. No.: 18/954,334

(22) Filed: Nov. 20, 2024

Related U.S. Application Data
(60) Provisional application No. 63/646,917, filed on May 13, 2024.

(51) Int. Cl. B25J 9/16

(52) U.S. Cl. CPC B25J 9/1661; B25J 9/161; B25J 9/163; B25J 9/1679

(57) ABSTRACT

According to one aspect, manipulation task solving may include sensing an object associated with a task including two or more sub-tasks, a state of an environment, a state of a robot appendage, and an action associated with the robot appendage, implementing the task based on a high-level policy including two or more low-level policies, and implementing the two or more sub-tasks based on the two or more low-level policies. A first low-level policy and a second low-level policy of the two or more low-level policies may be trained using different types of machine learning approaches or model-based control approaches. The two or more sub-tasks include reaching for the object and the first low-level policy may be associated with reaching for the object and may be trained based on a model-based control approach.

### CROSS-REFERENCE TO RELATED APPLICATIONS

This application claims the benefit of U.S. Provisional Patent Application, Ser. No. 63/646,917 (Attorney Docket No. HRA-56032) entitled “MANIPULATION TASK SOLVER”, filed on May 13, 2024; the entirety of the above-noted application(s) is incorporated by reference herein.

### BACKGROUND

Generally, there has been limited research on solving for long-horizon tasks using dexterous robot hands. For example, imagine a task of trying to pick up a wrench, positioning the wrench in a human hand, and using the wrench to tighten a bolt. While this task seems to be simple and intuitive to handle, the task poses numerous challenges for dexterous robot hands. Some of these challenges include sensing, trajectory generation to achieve a successful grasp, applying suitable contact forces to reorient the tool in-hand and transferring the tasks learnt in simulation to the hardware.

### BRIEF DESCRIPTION

According to one aspect, a manipulation task solver system may include a robot appendage, a sensor, a memory, and a processor. The sensor may sense an object associated with a task including two or more sub-tasks, a state of an environment, a state of the robot appendage, and an action associated with the robot appendage. The memory may store one or more instructions. The processor may execute one or more of the instructions stored on the memory to perform one or more acts, actions, and/or steps. For example, the processor may implement the task based on a high-level policy including two or more low-level policies and implement the two or more sub-tasks based on the two or more low-level policies. A first low-level policy and a second low-level policy of the two or more low-level policies may be trained using different types of machine learning approaches or model-based control approaches.

The two or more sub-tasks include reaching for the object, grasping the object, or reorienting the object after the object is grasped. The high-level policy may be trained by formulating the task as a long-horizon task Markov Decision Process (MDP). The two or more sub-tasks include reaching for the object and the first low-level policy may be associated with reaching for the object and may be trained based on a model-based control approach. The two or more sub-tasks include grasping the object and the second low-level policy may be associated with grasping the object and may be trained based on a reinforcement learning approach or an imitation learning approach. The two or more sub-tasks include reorienting the object after the object is grasped and a third low-level policy may be associated with reorienting the object after the object is grasped and may be trained based on a knowledge distillation or teacher-student model approach.

The teacher-student model approach may include a teacher model and a student model. The teacher model may be trained based on a pose of the robot appendage, a velocity of the robot appendage, a torque associated with of the robot appendage, one or more previous actions taken by the robot appendage, tactile information associated with the robot appendage, a pose of the object, a velocity of the object, a goal pose for the object or the robot appendage, and a distance from the goal pose. The student model may be trained based on supervision from the teacher model, real-world demonstrations, and one or more sensor inputs. The student model may be trained based on fewer inputs than the teacher model. One or more of the sensor inputs may include a pose of the robot appendage, a pose of the object, a goal pose for the object or the robot appendage, and tactile information from the robot appendage.

According to one aspect, a manipulation task solver system may include a robot appendage, a sensor, a memory, and a processor. The robot appendage may include an actuator. The sensor may sense an object associated with a task including three or more sub-tasks, a state of an environment, a state of the robot appendage, and an action associated with the robot appendage. The memory may store one or more instructions. The processor may execute one or more of the instructions stored on the memory to perform one or more acts, actions, and/or steps. For example, the processor may implement the task via the robot appendage and the actuator based on a high-level policy including three or more low-level policies and implement the three or more sub-tasks via the robot appendage and the actuator based on the three or more low-level policies. A first low-level policy, a second low-level policy, and a third low-level policy of the three or more low-level policies may be each trained using different types of machine learning approaches or model-based control approaches.

The high-level policy may be trained by formulating the task as a long-horizon task Markov Decision Process (MDP). The three or more sub-tasks include reaching for the object and the first low-level policy may be associated with reaching for the object and may be trained based on a model-based control approach. The three or more sub-tasks include grasping the object and the second low-level policy may be associated with grasping the object and may be trained based on a reinforcement learning approach or an imitation learning approach. The three or more sub-tasks include reorienting the object after the object is grasped and the third low-level policy may be associated with reorienting the object after the object is grasped and may be trained based on a knowledge distillation or teacher-student model approach.

According to one aspect, a computer-implemented method for manipulation task solving may include sensing an object associated with a task including two or more sub-tasks, a state of an environment, a state of a robot appendage, and an action associated with the robot appendage, implementing the task based on a high-level policy including two or more low-level policies, and implementing the two or more sub-tasks based on the two or more low-level policies. A first low-level policy and a second low-level policy of the two or more low-level policies may be trained using different types of machine learning approaches or model-based control approaches.

The high-level policy may be trained by formulating the task as a long-horizon task Markov Decision Process (MDP). The two or more sub-tasks include reaching for the object and the first low-level policy may be associated with reaching for the object and may be trained based on a model-based control approach. The two or more sub-tasks include grasping the object and the second low-level policy may be associated with grasping the object and may be trained based on a reinforcement learning approach or an imitation learning approach. The two or more sub-tasks include reorienting the object after the object is grasped and a third low-level policy may be associated with reorienting the object after the object is grasped and may be trained based on a knowledge distillation or teacher-student model approach.

### BRIEF DESCRIPTION OF THE DRAWINGS

FIG. 1 is an exemplary component diagram of a manipulation task solver system, according to one aspect.

FIG. 2 is an exemplary flow diagram of a computer-implemented method for manipulation task solving, according to one aspect.

FIG. 3 is an illustration of exemplary tasks associated with the manipulation task solver system of FIG. 1, according to one aspect.

FIG. 4 is an exemplary diagram of robot control strategies implemented by the manipulation task solver system of FIG. 1 and the computer-implemented method for manipulation task solving of FIG. 2, according to one aspect.

FIG. 5 is an exemplary flow diagram of imitation learning implemented by the manipulation task solver system of FIG. 1 and the computer-implemented method for manipulation task solving of FIG. 2, according to one aspect.

FIG. 6 is an exemplary flow diagram of reinforcement learning implemented by the manipulation task solver system of FIG. 1 and the computer-implemented method for manipulation task solving of FIG. 2, according to one aspect.

FIG. 7 is an exemplary diagram of robot control strategies implemented by the manipulation task solver system of FIG. 1 and the computer-implemented method for manipulation task solving of FIG. 2, according to one aspect.

FIG. 8 is an illustration of an example computing environment where one or more of the provisions set forth herein are implemented, according to one aspect.

FIG. 9 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, a robot appendage system including an actuator, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

Dexterous robot appendages should be able to perform long-horizon manipulation tasks that include multiple sub-tasks. Learning approaches and model-based approaches may be implemented to learn these sub-tasks individually. A wide range of research focuses on learning the sub-tasks using reinforcement learning. Hierarchical and sequential learning approaches may be leveraged to combine the policies for different sub-tasks to perform a long-horizon task. In this regard, different strategies (e.g., machine learning approaches or model-based control approaches) may be used to solve for different sub-tasks before combining them to solve a long-horizon task. In this disclosure, a processor may determine the method best suited for each sub-task and implement a hierarchical framework that unifies imitation learning, reinforcement learning, and model-based control to solve for different sub-tasks of a long-horizon task. An imitation learning approach may be used to learn dexterous manipulation tasks, followed by a teacher-student framework that combines real-world data into offline training. In this way, the hierarchical policy may combine different approaches to perform a long-horizon task. In other words, different segments of a long-horizon task may be solved using different machine learning approaches or model-based control approaches to improve efficiency and performance of the robot.

In this way, different approaches (e.g. machine learning or model-based control approaches) may be combined under a single framework, where each segment of a long-horizon task may be performed using a framework best suited for the sub-task. Different frameworks for solving each sub-task in a long-horizon task may be analyzed, and the best approach (e.g., least computationally expensive, etc.) may be determined for each sub-task. According to one aspect, the processor may provide a comparison of the different approaches and highlight the framework that is best suited to solve the respective sub-task. The processor may implement a hierarchical framework to unify the different frameworks to perform a long-horizon task.

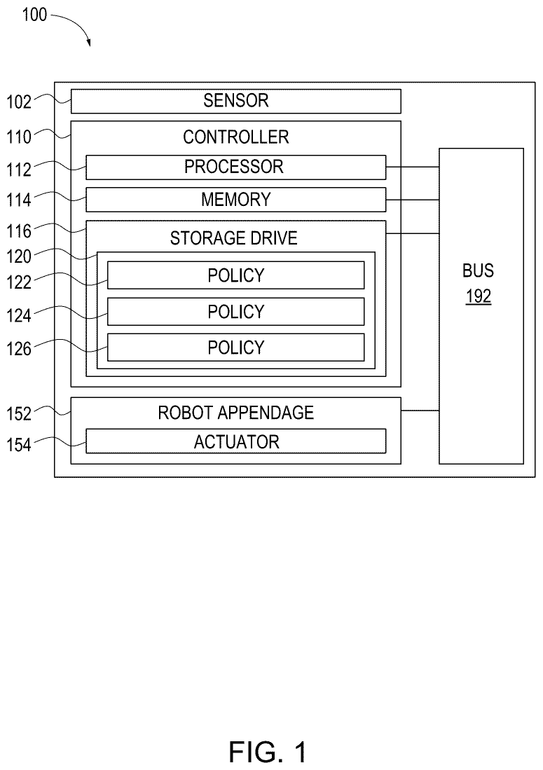

FIG. 1 is an exemplary component diagram of a manipulation task solver system 100, according to one aspect. The manipulation task solver system 100 may include a sensor 102 and a controller 110. The controller 110 may include a processor 112, a memory 114, and a storage drive 116. The storage drive 116 may store one or more policies. The manipulation task solver system 100 may be a robot and may include a robot appendage 152 and an actuator 154. According to one aspect, the robot appendage 152 may be a robotic arm and hand. A bus 192 may communicatively couple and enable computer communication between the sensor 102, the controller 110, and the robot appendage 152.

The sensor 102 may sense an object associated with a task including two or more sub-tasks, a state of an environment, a state of the robot appendage 152, and an action associated with the robot appendage 152. As described herein, the two or more sub-tasks may include reaching for the object, grasping the object, or reorienting the object after the object is grasped. However, other sub-tasks are contemplated. In any event, any number of sub-tasks may together form the task (e.g., a long-horizon task). According to another aspect, the processor 112 may track or determine the action associated with the robot appendage 152 based on a signal from the sensor 102.

The memory 114 may store one or more instructions. The processor 112 may execute one or more of the instructions stored on the memory 114 to perform one or more acts, actions, and/or steps.

The processor 112 may analyze the task and identify the two or more sub-tasks. Consider scenarios where the robot appendage 152 reaches for a tool, grasps the tool, and performs in-hand reorientation to hold the tool in a feasible position for use. Traditional model-based approaches may require a precise model of the environment and contact dynamics, while reinforcement learning approaches may require a fine-tuned reward function, and often take a large number of rollouts to learn the long-horizon task. To learn the same long-horizon tasks in a reasonable amount of time and without the need for precise dynamic models, the processor 112 may break down the long-horizon task into smaller sub-tasks and using different strategies for solving for each of these sub-tasks. Thus, the processor 112 may break down the task into multiple sub-tasks (e.g., reaching for the object, grasping the objects, reorienting the object, etc.). While the sub-tasks are discussed in terms of these three sub-tasks, other sub-tasks are contemplated, and fewer or more sub-tasks may be included in the task.

According to one aspect, solving for a sub-task such as reaching for a tool and carrying the tool to a desired location, a model of the environment may be defined without the consideration of complex finger gating or contact dynamics. In such tasks, where accuracy is of importance and a model is readily available, using reinforcement learning to learn a policy may lead to a policy that is sub-optimal or may have noise in reaching the desired pose. Also, a new policy may be trained for any change in the environment, making this approach computationally expensive in this scenario. On the other hand, collecting human demonstration data for a trivial task may be expensive and time consuming. To that end, for sub-task segments that do not need precise dynamic modelling or intricate finger gating trajectories, model-based control approaches may be employed to execute the sub-task. Since there is no learning involved with the model-based approaches, a change in the environment may be easily incorporated. In this disclosure, the processor 112 may use model-based trajectory optimization to solve for the reaching sub-tasks.

For the grasping sub-task, a model-based control approach may require defining a precise dynamics model for the object and the robot appendage 152. The grasping sub-task may require precise information about the contact dynamics and physical properties of the tool, which may be difficult to model. In this regard, the processor 112 may use imitation learning to solve for the grasping sub-task. On the other hand, reinforcement learning based approaches may require precise design of the reward function to enable the robot to learn grasping the object in a stable and legible manner with smooth actions. The design of such a dense reward function may require an expert fine-tuning effort. On the other hand, when the object is initialized in the robot's grasp, the robot may learn to reorient the object to the desired position with reinforcement learning without the need for complex fine tuning of the reward functions. In this disclosure, the processor 112 may implement a teacher-student approach for reinforcement learning for solving the in-hand reorientation task.

The processor 112 may implement the task via the robot appendage 152 and the actuator 154 based on a high-level policy 120 including two or more low-level policies. The high-level policy 120 may be trained by formulating the task as a long-horizon task Markov Decision Process (MDP). The processor 112 may implement the two or more sub-tasks via the robot appendage 152 and the actuator 154 based on the two or more low-level policies. According to one aspect, a first low-level policy 122, a second low-level policy 124, and/or a third low-level policy 126 of the two or more low-level policies may be each trained using different types of machine learning approaches or model-based control approaches.

For example, one of the sub-tasks may include reaching for the object and the first low-level policy 122 may be associated with reaching for the object and may be trained based on a model-based control approach. According to another example, one of the sub-tasks may include grasping the object and the second low-level policy 124 may be associated with grasping the object and may be trained based on an imitation learning approach. According to another example, one of the sub-tasks may include reorienting the object after the object is grasped and the third low-level policy 126 may be associated with reorienting the object after the object is grasped and may be trained based on a knowledge distillation or teacher-student model approach.

The processor 112 may define the problem of solving a long-horizon task as a Markov Decision Process (MDP), [symbol] = [symbol] , T, r, H [symbol] , where s^{t}∈ [symbol] is the state of the world and a^{t}∈ [symbol] is the action taken by the robot (e.g., including the robot appendage 152) at timestep t. The robot may transition to the next state s^{t+1} according to the transition function T(s^{t}, a^{t}). At each timestep, the robot may receive a reward from the environment defined by the reward function r: s^{t}, a^{t}← [symbol] and the interaction ends after maximum of H timesteps.

Using different machine learning algorithms or model-based control algorithms for solving for different segments of a long-horizon task may lead to efficient learning and successful task execution. The processor 112 may outline the approach of imitation learning and solve for grasping and pickup tasks. Additionally, the processor 112 may implement a teacher-student framework for reinforcement learning that learns in-hand reorientation by incorporating the real-world data into the training. The processor 112 may implement the model-based control approach in the framework for solving for the reaching sub-tasks. The processor 112 may implement a framework that combines all these approaches to solve for long-horizon dexterous manipulation tasks.

The processor 112 may provide details about training the imitation learning framework for dexterous manipulation and implement a teacher-student reinforcement learning approach incorporating real-world sparse data into an offline training phase. The processor 112 may formulate the hierarchical framework to unify the different approaches for solving long-horizon dexterous manipulation tasks.

### Imitation Learning

An imitation learning framework for grasping and pick up tasks using dexterous robot hands is depicted in FIG. 5. In imitation learning, the processor 112 may assume access to a set of expert provided demonstrations [symbol] ={ξ₁, ξ₂, . . . }, where

$${ξ}_{i} = \{ {s}_{i}^{0} , {a}_{i}^{0} , … {s}_{i}^{H} , {a}_{i}^{H} \} .$$

These demonstrations may be provided using any available teleoperation approach for dexterous manipulation. The processor 112 may then add zero mean gaussian noise ( [symbol] (0, σ)) to the demonstrations to make the dataset more diverse and the imitation learning policy robust to noise in the system. The processor 112 may add noise to states of the demonstrations while not altering the actions or the target states.

The processor 112 may use this dataset of augmented demonstrations to train a policy to grasp and pick up an object using imitation learning. In order to reduce the noise and the distribution shift during deployment, the processor 112 may train an ensemble of N policies with weights ε={θ₁, θ₂ . . . θ_{N}}. Each policy may be trained to predict n actions in the future (look-ahead) by minimizing the Mean-Squared-Error loss function defined as:

$$ℒ = {\sum }_{ξ ∈ 𝒟} {\sum }_{s , {a}_{n}^{*} ∈ ξ} {‖ {a}_{n} - {a}_{n}^{*} ‖}^{2} \qquad ( 1 )$$

where aₙ={a^{t}, a^{t+1} . . . a^{t+n}} is the set of predicted actions,

$${a}_{n}^{*}$$

is the set of optimal actions from a given state s, and ∥(⋅)∥ represents the L2 norm.

According to one aspect, each of the policies in the ensemble may include a fully connected multilayer perceptron with 5 hidden layers and rectified linear activation units. For example, the ensemble may include ten independently trained policies, where each model optimizes the network weights using an Adam optimizer with a learning rate of 0.001. On deployment, the processor 112 may use the ensemble of policies & to predict a set of N actions and the average of these N actions is used as a control input to the robot to minimize the uncertainty in action prediction. Since this framework depends on the state of the system and not on the visual feedback, the learned policy may not be affected by visual occlusions of the hand or the object.

### Reinforcement Learning

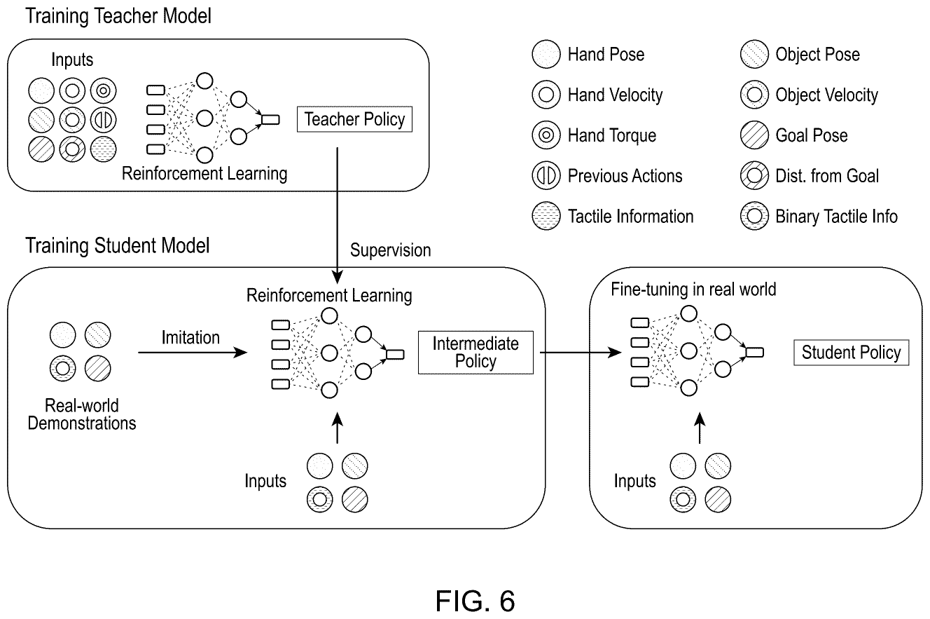

With reference to FIG. 6, the teacher-student model approach may include a teacher model and a student model. The teacher model may be trained based on a pose of the robot appendage 152, a velocity of the robot appendage 152, a torque associated with of the robot appendage 152, one or more previous actions taken by the robot appendage 152, tactile information associated with the robot appendage 152, a pose of the object, a velocity of the object, a goal pose for the object or the robot appendage 152, and a distance from the goal pose. The student model may be trained based on supervision from the teacher model, real-world demonstrations, and one or more sensor inputs. One or more of the sensor inputs may include a pose of the robot appendage 152, a pose of the object, a goal pose for the object or the robot appendage 152, and tactile information from the robot appendage 152.

Teacher-student frameworks may learn in-hand object reorientation, where the teacher is trained with privileged information (e.g., information not available in real world), and the student's observation space is made sparse while using domain randomization and the teacher's actions to learn a robust reinforcement learning policy. Explained yet again, the student model may be trained on a sparse set of inputs (e.g., a set of inputs smaller than the set of inputs provided to the teacher model) that may be readily available in the real world. In this way, the student model may be trained based on fewer inputs than the teacher model. In the framework of the system, instead of just relying on domain randomization and the teacher policy for training the student, real-world data may be collected and incorporated in the student's learning framework to make the policy robust for real world tuning and deployment.

Teacher Policy: The learning of teacher policy π^{T} may be framed as a reinforcement learning problem where the teacher observes the state of the world s^{t} at a timestep t, takes an action a^{t} and receives a reward r(s^{t}, a^{t}) from the environment. The policy may be trained using proximal policy optimization (PPO) to maximize the expected discounted return of the episode

$${π}_{T *} = {arg max}_{{π}_{T}} 𝔼 {\sum }_{t = 1}^{H} {γ}^{t} \cdot r ( {s}^{t} , {a}^{t} ) ,$$

where γ is the discount factor.

The teacher model's observation space may include privileged information that is not necessarily available in the real world, but accessible in the simulation. This privileged information may include precise tool and hand joint position and velocity, hand joint torques, tactile force information and feature information for the task, as shown in FIG. 6. The reward function for training this privileged teacher model may be given as:

$${r}_{T} ( {s}^{t} , {a}^{t} ) = {α}_{1} \frac{1}{‖ {Δθ}^{t} ‖ + {ϵ}_{θ}} dense task reward \qquad ( 2 )$$

$$+ {α}_{2} \vert {\dot{q}}^{t} - {\dot{q}}^{t - 1} \vert action penalty \qquad ( 3 )$$

$$+ {α}_{3} ‖ {τ}^{t} ‖ torque penalty \qquad ( 4 )$$

$$+ {α}_{4} ( task success ) success bonus \qquad ( 5 )$$

$$+ {α}_{5} ( tool dropped ) failure penalty \qquad ( 6 )$$

where Δθ^{t} is the distance from the desired tool orientation, q^{t} represents the joint states of the robot hand, τ^{t} is the torque applied by the joints, and [symbol] is an indicator function. α₁, α₄, ϵ_{θ}>0 and α₂, α₃, α₅<0 are constants that determine the relative weight of terms in the reward function. According to one aspect, the processor 112 may use α₁=1.0, α₂=−0.1, α₃=−0.01, α₄=250, α₅=−100 and ϵ_{θ}=0.001.

Student Policy: Now the observation space and the reward function used to train the teacher model are defined, the training of the student model may occur. As discussed herein, the student model may be trained with data that is obtainable in the real world. To that end, the observation space of the student model is a subset of the observation space of the teacher which includes the hand and tool pose, the goal pose and binary tactile information as shown in FIG. 6. However, binary tactile information as accurate 3D tactile information may be difficult to obtain in the real world.

Pre-Training: To incorporate real world data in the training of the student model, the student model may be pre-trained demonstrations for the reorientation task collected in the real world. Demonstrations may be collected using any teleoperation framework. The imitation learning policy may then be trained, with no look ahead data (e.g., n=1). Even though these demonstrations may not be enough to learn accurately the complex task of reorientation, this may initialize the student model with a baseline policy including real world data.

RL with teacher supervision: Next, the baseline policy may be built, trained using imitation learning and real-world data to train the student model using reinforcement learning. Similar to the teacher model, the student model may be trained using PPO to maximize the expected return of the episode

$${π}_{S - T} = {arg max}_{{π}_{S - T}} 𝔼 {\sum }_{t = 1}^{H} {γ}^{t} \cdot r ( {s}^{t} , {a}^{t} ) .$$

The student with a sparse observation space and the teacher supervision is trained using the following reward function:

$${r}_{S} ( {s}^{t} , {a}^{t} ) = {α}_{1} \frac{1}{‖ {Δθ}^{t} ‖ + {ϵ}_{θ}} dense task reward \qquad ( 7 )$$

$$+ {α}_{2} ‖ {a}_{T}^{t} - {a}_{S}^{t} ‖ teacher supervision \qquad ( 8 )$$

$$+ {α}_{3} ( task success ) success bonus \qquad ( 9 )$$

$$+ {α}_{4} ( tool dropped ) failure penalty \qquad ( 10 )$$

where α_{T} and α_{S} are the teacher and student actions, respectively. According to one aspect, the processor 112 may set α₁=1.0, α₂=−0.1, α₃=250, α₄=−100, as the relative weights of the terms in the reward function and ϵ_{θ}=0.001.

Even though the student model may be pre-trained with real-world demonstrations, the student model may not be able to work zero-shot in the real world only after training in the simulation. To enable a smooth simulation to real-world transfer, the student policy may be trained in simulation with teacher supervision on real hardware without any teacher supervision (α₂=0). This enables the student policy to fine tune network weights to adapt to the physics parameters of the hardware and the control parameters of the robot appendage.

### Model-Based Control Approach

For model-based control, the processor 112 may assume access to a model of the environment and the related constraint parameters in the form of a reward function r_{θ}(s^{t}). This reward function may be customized or learned from demonstrations from a human user. As discussed, for tasks where the environment constraints change frequently, and where a dynamic model of the environment is readily available, model-based approaches may be utilized to generate reliable robot trajectories. In this setting, the processor 112 may leverage the underlying robot kinematics and constrained optimization to solve for the optimal robot trajectory:

$${ξ}_{r} = {arg max}_{ξ ∈ Ξ} {\sum }_{s ∈ ξ} {r}_{θ} ( s ) s . t . ξ ( 0 ) = {s}^{0} , ξ ( H ) = {s}^{H} \qquad ( 11 )$$

where ξᵣ is the generated robot trajectory, Ξ is the set of all possible trajectories in the environment and s₀ and s_{H} are the start and the goal positions for the robot, respectively.

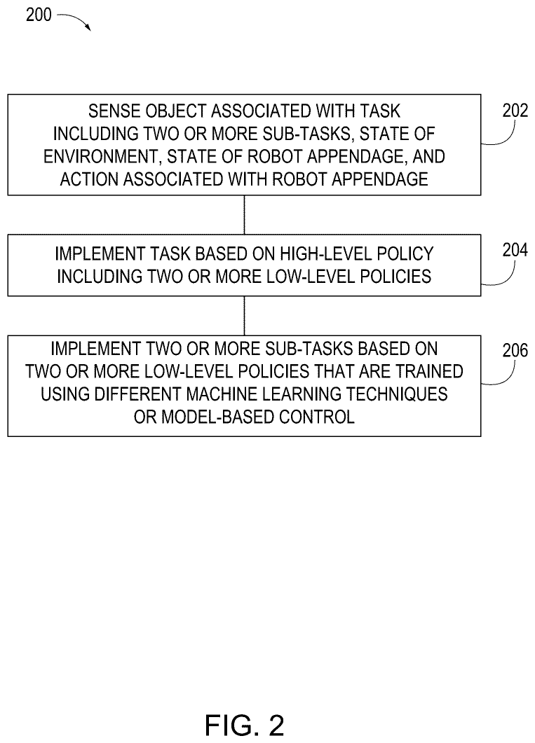

FIG. 2 is an exemplary flow diagram of a computer-implemented method 200 for manipulation task solving, according to one aspect. The computer-implemented method 200 for manipulation task solving may include sensing 202 an object associated with a task including two or more sub-tasks, a state of an environment, a state of a robot appendage, and an action associated with the robot appendage, implementing 204 the task based on a high-level policy including two or more low-level policies, and implementing 206 the two or more sub-tasks based on the two or more low-level policies. A first low-level policy and a second low-level policy of the two or more low-level policies may be trained using different types of machine learning approaches or model-based control approaches.

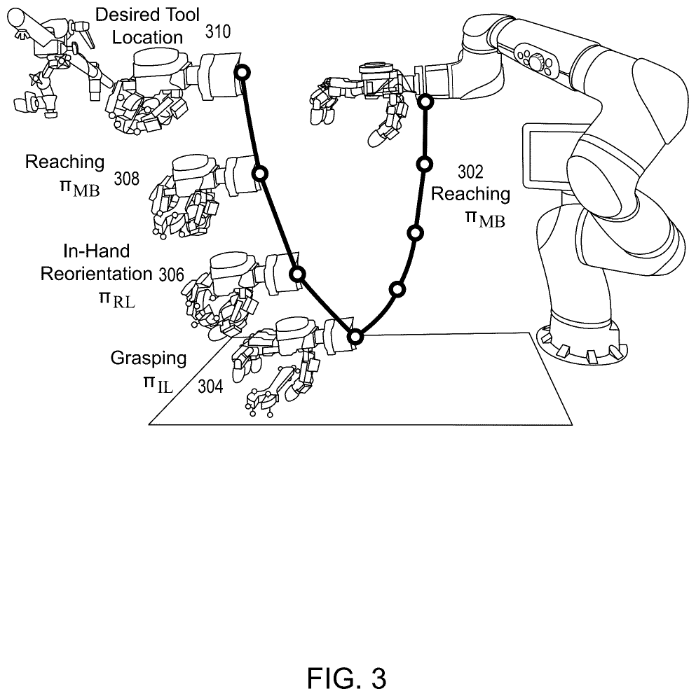

FIG. 3 is an illustration of exemplary tasks associated with the manipulation task solver system of FIG. 1, according to one aspect. As seen in FIG. 3, a task or a long-horizon task may be broken down into two or more sub-tasks. Examples of sub-tasks may include reaching 302 for an object, grasping 304 an object, reorientation 306 of the object after the object is grasped initially, reaching 308 to a goal pose, stopping 310 at the goal pose, etc.

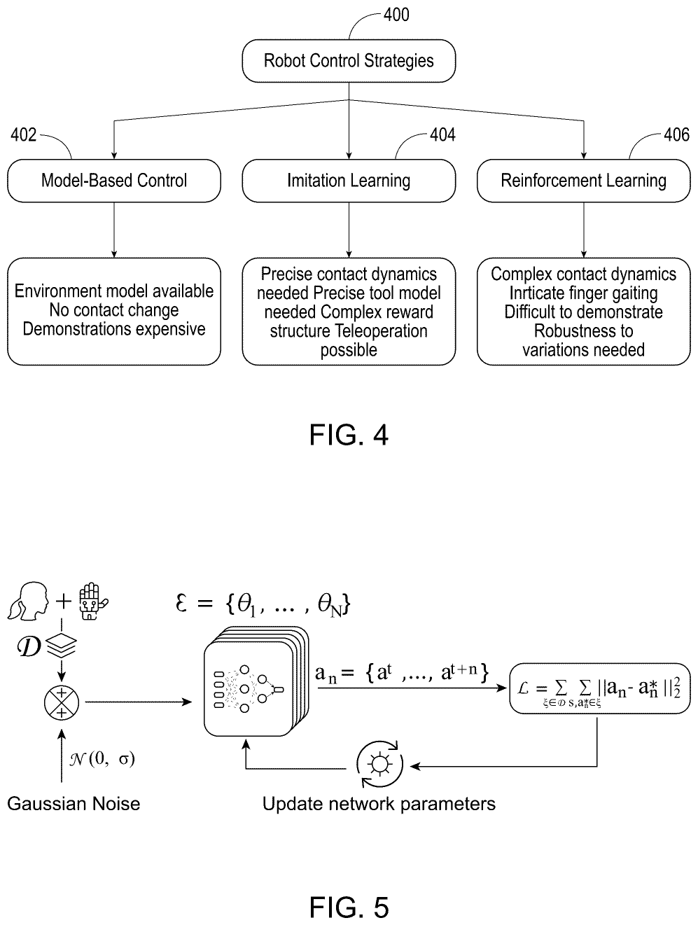

FIG. 4 is an exemplary diagram of robot control strategies 400 implemented by the manipulation task solver system of FIG. 1 and the computer-implemented method for manipulation task solving of FIG. 2, according to one aspect. The robot control strategies 400 may include different types of machine learning approaches or model-based control approaches. Examples of different types of machine learning approaches or model-based control approaches include model-based control 402, imitation learning 404, reinforcement learning 406, etc. Each type of approach may have its own benefits and/or advantages. For example, with regard to model-based control 402, no demonstrations are required, and thus, may be easier to train in this regard. With regard to imitation learning 404, demonstrations may be utilized, but a model may be more computationally expensive to train due to complexity, and thus, demonstrations may be better suited when precise contact dynamics are involved. With regard to reinforcement learning 406, robustness may be provided when a task has a variety of variations for demonstration.

FIG. 5 is an exemplary flow diagram of imitation learning implemented by the manipulation task solver system of FIG. 1 and the computer-implemented method for manipulation task solving of FIG. 2, according to one aspect.

FIG. 6 is an exemplary flow diagram of reinforcement learning implemented by the manipulation task solver system of FIG. 1 and the computer-implemented method for manipulation task solving of FIG. 2, according to one aspect.

### Unified Policy

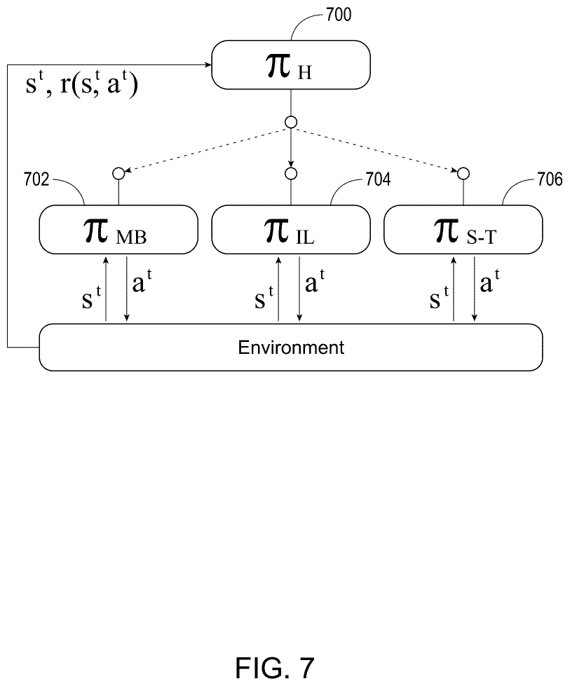

FIG. 7 is an exemplary diagram of robot control strategies implemented by the manipulation task solver system of FIG. 1 and the computer-implemented method for manipulation task solving of FIG. 2, according to one aspect. A high-level policy 700 may include two or more low-level policies. For example, as seen in FIG. 7, there are three low-level policies 702, 704, 706 included within the high-level policy 700. A state of the environment, a state of the robot appendage, and an action associated with the robot appendage may be provided to the high-level policy as an input. The high-level policy 700 may be utilized to determine a type of sub-task applicable, and implement the corresponding low-level policy 702, 704, 706 based on the type of sub-task being performed.

Now that the processor has defined the different aspects of the long-horizon task and the training methodologies to be used to train for each individual aspect, different policies may be combined under a unified framework. The processor may use a high-level policy π_{H} that determines which of the frameworks is to be used based on the current state of the environment. At each timestep t, π_{H} may observe the state of the environment (e.g., the combination of the observation space of all the other policies), and the outputs the lower-level policy to be implemented. A low-level policy (e.g., 702, 704, 706) may be executed and π_{H} may receive a reward r(sₜ, aₜ) from the environment. The objective of TH is to maximize the expected return for the episode. This policy TH may be trained to maximize this expected return using any reinforcement learning algorithm. According to one aspect, π_{H} is a logical interpreter that determines the framework to be used based on the state of the environment. The processor may use this custom logical interpreter to reduce the overall training time for a single long-horizon task. However, it may be useful to use reinforcement learning to train this policy when the number of objects and the tasks in the environment increase.

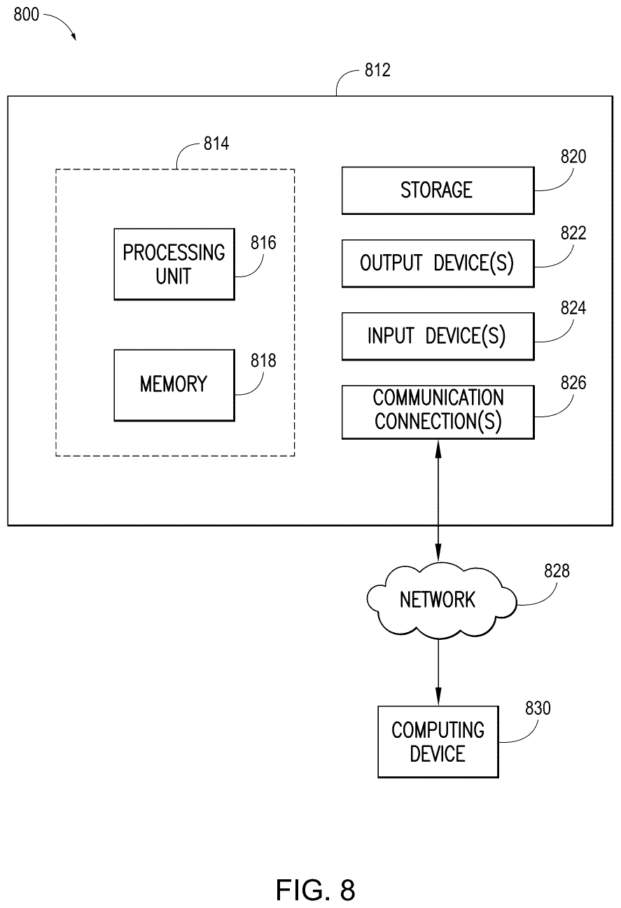

FIG. 8 and the following discussion provide a description of a suitable computing environment to implement aspects of one or more of the provisions set forth herein. The operating environment of FIG. 8 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 8 illustrates a system 800 including a computing device 812 configured to implement one aspect provided herein. In one configuration, the computing device 812 includes at least one processing unit 816 and memory 818. Depending on the exact configuration and type of computing device, memory 818 may be volatile, such as RAM, non-volatile, such as ROM, flash memory, etc., or a combination of the two. This configuration is illustrated in FIG. 8 by dashed line 814.

In other aspects, the computing device 812 includes additional features or functionality. For example, the computing device 812 may include additional storage such as removable storage or non-removable storage, including, but not limited to, magnetic storage, optical storage, etc. Such additional storage is illustrated in FIG. 8 by storage 820. In one aspect, computer readable instructions to implement one aspect provided herein are in storage 820. Storage 820 may store other computer readable instructions to implement an operating system, an application program, etc. Computer readable instructions may be loaded in memory 818 for execution by the at least one processing unit 816, for example.

The term “computer readable media” as used herein includes computer storage media. Computer storage media includes volatile and nonvolatile, removable, and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 812. Any such computer storage media is part of the computing device 812.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 812 includes input device(s) 824 such as keyboard, mouse, pen, voice input device, touch input device, infrared cameras, video input devices, or any other input device. Output device(s) 822 such as one or more displays, speakers, printers, or any other output device may be included with the computing device 812. Input device(s) 824 and output device(s) 822 may be connected to the computing device 812 via a wired connection, wireless connection, or any combination thereof. In one aspect, an input device or an output device from another computing device may be used as input device(s) 824 or output device(s) 822 for the computing device 812. The computing device 812 may include communication connection(s) 826 to facilitate communications with one or more other devices 830, such as through network 828, for example.

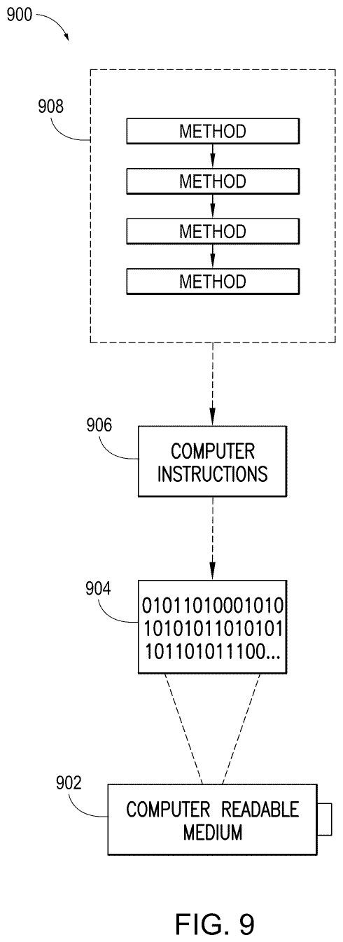

Still another aspect involves a computer-readable medium including processor-executable instructions configured to implement one aspect of the techniques presented herein. An aspect of a computer-readable medium or a computer-readable device devised in these ways is illustrated in FIG. 9, wherein an implementation 900 includes a computer-readable medium 902, such as a CD-R, DVD-R, flash drive, a platter of a hard disk drive, etc., on which is encoded computer-readable data 904. This encoded computer-readable data 904, such as binary data including a plurality of zero's and one's as shown in 904, in turn includes a set of processor-executable computer instructions 906 configured to operate according to one or more of the principles set forth herein. In this implementation 900, the processor-executable computer instructions 906 may be configured to perform a method 908, such as the computer-implemented method 200 for computer-implemented method for manipulation task solving of FIG. 2. In another aspect, the processor-executable computer instructions 906 may be configured to implement a system, such as the manipulation task solver system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A manipulation task solver system, comprising:
a robot appendage;
a sensor sensing an object associated with a task including two or more sub-tasks, a state of an environment, a state of the robot appendage, and an action associated with the robot appendage;
a memory storing one or more instructions; and
a processor executing one or more of the instructions stored on the memory to perform:
implementing the task based on a high-level policy including two or more low-level policies; and
implementing the two or more sub-tasks based on the two or more low-level policies, wherein a first low-level policy and a second low-level policy of the two or more low-level policies are trained using different types of machine learning approaches or model-based control approaches.

2. The manipulation task solver system of claim 1, wherein the two or more sub-tasks include reaching for the object, grasping the object, or reorienting the object after the object is grasped.

3. The manipulation task solver system of claim 1, wherein the high-level policy is trained by formulating the task as a long-horizon task Markov Decision Process (MDP).

4. The manipulation task solver system of claim 1, wherein the two or more sub-tasks include reaching for the object and wherein the first low-level policy is associated with reaching for the object and is trained based on a model-based control approach.

5. The manipulation task solver system of claim 1, wherein the two or more sub-tasks include grasping the object and wherein the second low-level policy is associated with grasping the object and is trained based on a reinforcement learning approach or an imitation learning approach.

6. The manipulation task solver system of claim 1, wherein the two or more sub-tasks include reorienting the object after the object is grasped and wherein a third low-level policy is associated with reorienting the object after the object is grasped and is trained based on a knowledge distillation or teacher-student model approach.

7. The manipulation task solver system of claim 6, wherein the teacher-student model approach includes a teacher model and a student model.

8. The manipulation task solver system of claim 7, wherein the teacher model is trained based on a pose of the robot appendage, a velocity of the robot appendage, a torque associated with of the robot appendage, one or more previous actions taken by the robot appendage, tactile information associated with the robot appendage, a pose of the object, a velocity of the object, a goal pose for the object or the robot appendage, and a distance from the goal pose.

9. The manipulation task solver system of claim 7, wherein the student model is trained based on supervision from the teacher model, real-world demonstrations, and one or more sensor inputs.

10. The manipulation task solver system of claim 7, wherein the student model is trained based on fewer inputs than the teacher model.

11. A manipulation task solver system, comprising:
a robot appendage including an actuator;
a sensor sensing an object associated with a task including three or more sub-tasks, a state of an environment, a state of the robot appendage, and an action associated with the robot appendage;
a memory storing one or more instructions; and
a processor executing one or more of the instructions stored on the memory to perform:
implementing the task via the robot appendage and the actuator based on a high-level policy including three or more low-level policies; and
implementing the three or more sub-tasks via the robot appendage and the actuator based on the three or more low-level policies, wherein a first low-level policy, a second low-level policy, and a third low-level policy of the three or more low-level policies are each trained using different types of machine learning approaches or model-based control approaches.

12. The manipulation task solver system of claim 11, wherein the high-level policy is trained by formulating the task as a long-horizon task Markov Decision Process (MDP).

13. The manipulation task solver system of claim 11, wherein the three or more sub-tasks include reaching for the object and wherein the first low-level policy is associated with reaching for the object and is trained based on a model-based control approach.

14. The manipulation task solver system of claim 11, wherein the three or more sub-tasks include grasping the object and wherein the second low-level policy is associated with grasping the object and is trained based on a reinforcement learning approach or an imitation learning approach.

15. The manipulation task solver system of claim 11, wherein the three or more sub-tasks include reorienting the object after the object is grasped and wherein the third low-level policy is associated with reorienting the object after the object is grasped and is trained based on a knowledge distillation or teacher-student model approach.

16. A computer-implemented method for manipulation task solving, comprising:
sensing an object associated with a task including two or more sub-tasks, a state of an environment, a state of a robot appendage, and an action associated with the robot appendage;
implementing the task based on a high-level policy including two or more low-level policies; and
implementing the two or more sub-tasks based on the two or more low-level policies, wherein a first low-level policy and a second low-level policy of the two or more low-level policies are trained using different types of machine learning approaches or model-based control approaches.

17. The computer-implemented method for manipulation task solving of claim 16, wherein the high-level policy is trained by formulating the task as a long-horizon task Markov Decision Process (MDP).

18. The computer-implemented method for manipulation task solving of claim 16, wherein the two or more sub-tasks include reaching for the object and wherein the first low-level policy is associated with reaching for the object and is trained based on a model-based control approach.

19. The computer-implemented method for manipulation task solving of claim 16, wherein the two or more sub-tasks include grasping the object and wherein the second low-level policy is associated with grasping the object and is trained based on a reinforcement learning approach or an imitation learning approach.

20. The manipulation task solver system of claim 1, wherein the two or more sub-tasks include reorienting the object after the object is grasped and wherein a third low-level policy is associated with reorienting the object after the object is grasped and is trained based on a knowledge distillation or teacher-student model approach.
